(19) United States
(12) Patent Application Publication
(10) Pub. No.: US 2008/0260920 A1
(43) Pub. Date: Oct. 23, 2008

(54) METHOD FOR PACKAGING AND STORING FRESH MEAT PRODUCTS

(76) Inventor: Eldon Roth, Dakota Dunes, SD (US)

Correspondence Address: THE CULBERTSON GROUP, P.C., 1114 LOST CREEK BLVD., SUITE 420, AUSTIN, TX, 78746, US

(21) Appl. No.: 12/105,946

(22) Filed: Apr. 18, 2008

Related U.S. Application Data
(60) Provisional application No. 60/913,412, filed on Apr. 23, 2007.

(51) Int. Cl. A23B 4/12; A23B 4/18; A23L 1/31

(52) U.S. Cl. 426/281; 426/326

(57) ABSTRACT

A method of treating and storing fresh meat products includes applying an aqueous pH-modified solution in an effective amount to a surface of a fresh meat product at a surface penetrating force. The aqueous pH-modified solution that is applied has a pH that is compatible with the meat product and has a temperature that is compatible with a storage temperature at which the meat product will be stored. The method also includes maintaining the treated meat product in an atmosphere containing oxygen while the treated meat product is stored. Maintaining the treated meat product in the atmosphere containing oxygen may be accomplished by packaging the treated meat product in a package that includes an oxygen permeable film. In order to apply the aqueous pH-modified solution to the surface of the meat product at the surface penetrating force, the solution may be accelerated through a spray nozzle having an elongated orifice that provides a continuous curtain of the solution. The spray nozzle and/or the meat product are moved relative to each other to provide a consistent application force across the entire surface of the meat product.

### CROSS-REFERENCE TO RELATED APPLICATION

This application claims the benefit under 35 U.S.C. §119(e) of U.S. Provisional Patent Application Ser. No. 60/913,412, filed Apr. 23, 2007, and entitled “Method for Packaging and Storing Fresh Meat Products.” The entire content of this prior application is incorporated herein by this reference.

### TECHNICAL FIELD OF THE INVENTION

This invention relates to meat processing operations and to meat product packaging and storage techniques. More particularly, the invention relates to methods for treating fresh meat products to facilitate extended storage.

### BACKGROUND OF THE INVENTION

Red meat products are typically sold to consumers in the form of individual cuts of meat such as steaks, roasts, or filets, or in a more highly comminuted form such as ground meat or cubed stew meat. According to the traditional meat distribution model, only initial processing was performed at a centralized location. This initial processing cut the animal carcass into sides or quarters and these large pieces of product were cut down to final consumer form at retail and wholesale butcher shops. Although this traditional distribution model persists, the majority of fresh (unfrozen and uncooked) consumer meat products are today distributed under a model that includes more centralized processing. Under this more modern distribution model, sides or quarters of the animal carcass are both cut down into the final consumer form and packaged for retail sale at a centralized processing facility, and the resulting packaged steaks, roasts, filets, and ground or cubed products are transported to various retail outlets. In addition to economies of scale, this more centralized processing model for meat product distribution has the advantage that skilled labor and specialized meat processing equipment are required only at the centralized processing facility and not at the retail outlet.

Although the centralized processing model is widely employed, there remain significant disadvantages to this distribution model. Perhaps the greatest disadvantage of the modern, centralized processing distribution model for fresh meat products relates to the shelf life for the packaged product. The packaged meat product must remain wholesome and attractive to consumers over the course of the time it may take for the product to be transported from the centralized processing facility to the retail outlet, held in a retail display case, and then stored by the consumer until ultimately cooked. However, the shelf life for traditionally packaged meat products extends only a few days at storage temperatures between 40° F. and 33° F. Beyond a few days at this storage temperature, the growth of spoilage bacteria in the meat product may leave the product unusable. Aside from the problem of spoilage bacteria there is the problem of retaining an attractive color in the packaged meat product over the course of transport, display, and storage. Freshly cut red meat such as beef takes on the familiar and desirable bright red color when the meat is exposed to an atmosphere containing a significant oxygen content, such as air for example. This desirable bright red color results largely from the absorption of oxygen in the meat product to convert myoglobin in the meat to oxymyoglobin. However, if the meat continues to be held in an oxygen rich environment such as air for an extended period of time, the oxygen may react with fats in the meat to make the meat rancid. If the meat is held in an oxygen poor environment after forming the desired bright red color from oxymyoglobin, the oxymyoglobin in the meat tends to convert to metmyoglobin to produce a generally undesirable brown color in the meat. The formation of metmyoglobin in the meat product also adversely affects the flavor of the meat upon cooking.

Various packaging and processing techniques have been developed in an effort to extend the shelf life of fresh meat products. One packaging technique has been to package the meat product in a low oxygen atmosphere for transport to the retail location, and then modify the package to expose the product to oxygen immediately before placing the product in the consumer display case. The package modification may be to peel a gas impermeable film from the product package or to remove the product package from a larger oxygen-impermeable container. In any event, the exposure to oxygen allows the meat to turn the desirable bright red color from the formation of oxymyoglobin. This delayed formation of the desirable bright red color due to the delayed exposure to an oxygen rich atmosphere is commonly referred to as “bloom.” Since the exposure to oxygen is delayed until the time the product is placed out for retail sale, this low oxygen packaging technique delays the problem of oxidation rancidity in the meat. However, the modification of the package to allow the exposure to oxygen at the retail location is labor intensive and requires special packaging materials. Also, the requirement of peeling a layer of packaging material effectively requires labeling or relabeling of the package at the retail location. However, labeling or relabeling the packaged meat product at the retail location is labor intensive and generally undesirable.

Aside from packaging techniques to provide extended shelf life, various treatments have been attempted to help maintain a desirable color in fresh meat products. For example, it is known that exposing a red meat product to carbon monoxide under certain conditions produces carboxymyoglobin in the meat product which causes the meat to take on a bright red color. However, this bright red color resulting from the formation of carboxymyoglobin may undesirably remain in the meat even after the meat is cooked. Furthermore, the bright red color produced by carbon monoxide exposure may mask spoilage in the meat product.

The meat processing industry continues to search for some treatment technique or packaging technique that will provide an extended shelf life for the packaged meat product and thereby facilitate the desired centralized processing of meat products.

### SUMMARY OF THE INVENTION

The present invention provides a method for treating fresh meat products with an aqueous pH-modified solution so that the treated meat product retains a desirable bright red color for extended periods upon storage in an atmosphere containing oxygen. The invention encompasses both methods and apparatus for treating meat products.

One preferred method of treating and storing meat products includes applying an aqueous pH-modified solution (also referred to herein simply as a “pH-modified solution) in an effective amount to a first surface of the meat product at a surface penetrating force. The aqueous pH-modified solution that is applied has a pH that is compatible with the meat product and also a temperature that is compatible with the meat product. This pH and temperature compatibility will be described further below, as will the surface penetrating force and effective amount of the pH-modified solution. The method also includes maintaining the treated meat product in an atmosphere containing oxygen while the treated meat product is stored. It is believed that a certain minimum oxygen availability is necessary during storage to allow the treated meat product to retain the desired bright red color and prevent the development of brown color in the meat which is believed to be indicative of metmyoglobin formation. However, the treatment according to the present invention has been found to inhibit rancidity oxidation in the meat product even over the course of extended periods of time in an oxygen-rich environment such as air. Furthermore, the pH of the aqueous pH-modified solution applied according to the invention may be sufficiently high or low to effectively kill microbes at or near the surface of the meat product to greatly reduce the growth of spoilage bacteria in the meat and, provided that the treated meat is protected from surface contamination, help the treated meat remain wholesome even after extended storage.

In some preferred forms of the invention, the treated meat product is packaged immediately after applying the aqueous pH-modified solution in order to protect the surface of the treated meat from contamination. In these forms of the invention, the packaging employed is preferably an isolating package made up of packaging materials that block microbes from reaching the meat product. However, the packaging retains some arrangement for maintaining an oxygen-containing atmosphere in the interior of the isolating package, that is, for enabling oxygen to enter the interior of the package or be released into the interior of the package at a rate sufficient to inhibit the development of the undesirable brown color in the meat during storage. An arrangement for enabling oxygen to enter the interior of the package may be a suitable valve or other opening, or more preferably, an oxygen-permeable over-wrap film having a minimum oxygen transmission rate as will be described further below in the description of preferred embodiments section. An arrangement for releasing oxygen into the package may include a suitable oxygen carrier contained in the interior of the package along with the meat, the oxygen carrier having the ability to release oxygen into the package at a suitable rate.

The surface penetrating force at which the aqueous pH-modified solution is applied to the surface of the meat product is a force that is believed to allow the pH-modified solution to penetrate the surface of the meat product to a depth that allows the meat to retain the desirable red color during storage without bleed-through of color-affecting materials from the interior of the meat product. It is believed that a surface penetrating force sufficient to cause the pH modified solution to penetrate to a depth of at least approximately one-sixteenth to approximately one-eighth of an inch represents a suitable surface penetrating force. A surface penetrating force sufficient to cause the solution to penetrate to a depth of as little as approximately one sixty-fourth of an inch, or between approximately one thirty-second of an inch and one-sixteenth of an inch may also be acceptable. It is noted that the penetration depth of the pH-modified solution has been identified experimentally by the depth at which the effect of the pH-modified solution is visible in the treated meat. It is believed that this depth of visible effect indicates or at least approximates the actual depth of penetration of the pH-modified solution. However, it is possible that the actual depth of penetration, that is, the depth to which the pH-modified material penetrates below the surface of the meat product by virtue of the surface penetrating force (application force), deviates from the depth at which the affect of the pH-modified solution is visible after application at the surface penetrating force.

A preferred device for applying the aqueous pH-modified solution at the surface penetrating force comprises a structure providing an elongated, narrow orifice that extends substantially the length or width of the meat to be treated. This elongated orifice structure provides a substantially continuous curtain of the aqueous pH-modified solution at a flow velocity that is believed to provide the surface penetrating force, and allows the aqueous pH-modified solution to be quickly and uniformly applied to the surface of the meat product. It is believed that this low flow, high velocity arrangement for applying the aqueous pH-modified solution avoids having to soak the meat product in the solution which in turn avoids problems associated with extended contact between the meat and certain treatment materials suitable for use in an aqueous pH-modified solution according in the present invention.

The present invention may be applied to any raw or at least partially uncooked meat product including red meat products such as beef, pork, veal, lamb, and mutton. The invention may also be applied to raw or partially uncooked fowl meat such as chicken, turkey, goose, and duck meat, and to seafoods. Thus, the designation “meat product” as used in this disclosure and the accompanying claims, and unless specifically limited further, may refer to any fresh meat product including lean portions, fat, and related materials, and including fresh meat products to which additives such as flavorings, extenders, tenderizing agents, and other materials have been added. The designation “fresh” in connection with “meat product” means that the meat product is unfrozen at the time of treatment at least to a depth of approximately one-eighth of an inch for a surface being treated according to the invention, and that the surface of the meat product being treated is uncooked or at least partially uncooked. Although the present invention has application to any fresh meat product, it is believed that the invention is particularly applicable to the red meats described above due to the nature of the color in the uncooked meat.

The designation “treated meat product” will be used generally in this disclosure to refer to the meat product after the aqueous pH-modified solution is applied, regardless of whether other materials are also applied to the surface of the meat product, or injected into the interior of the meat product. Other materials such as bases, buffering acids, and materials that increase oxygen content may also be separately applied to the meat product pursuant to the present invention. The various application parameters for these other materials and the pH-modified solution, as well as the preferred treatment materials themselves will be described below in the description of preferred embodiments section and in connection with the examples.

These and other advantages and features of the invention will be apparent from the following description of the preferred embodiments, considered along with the accompanying drawings.

### BRIEF DESCRIPTION OF THE DRAWINGS

FIG. 1 is a block diagram illustrating the steps in one preferred treatment method embodying the present invention.

FIG. 2 is a block diagram illustrating another preferred treatment method according to the present invention.

FIG. 3 is a block diagram illustrating another preferred treatment method according to the present invention.

FIG. 4 is a diagrammatic representation of a system for treating meat products with an aqueous pH-modified solution according to the present invention.

FIG. 5 is a diagrammatic side view of a surface application system that may be used in the treatment system shown in FIG. 4.

FIG. 6 is a diagrammatic top view of the surface application system shown in FIG. 5.

FIG. 7 is a transverse section view taken along line 7-7 in FIG. 6.

FIG. 8 is a diagrammatic representation of one preferred arrangement for producing an aqueous pH-modified solution for use in the present invention.

FIG. 9 is a diagrammatic representation of a test system that was used in certain examples described below.

FIGS. 10A-D each comprises a table showing results of certain tests described in the example section below.

### DESCRIPTION OF PREFERRED EMBODIMENTS

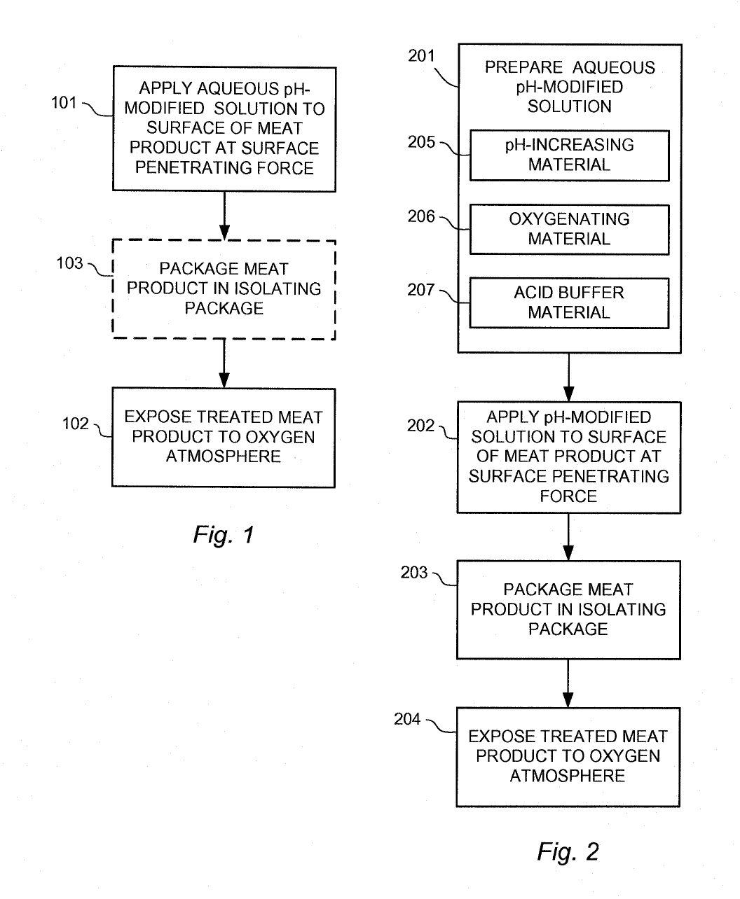

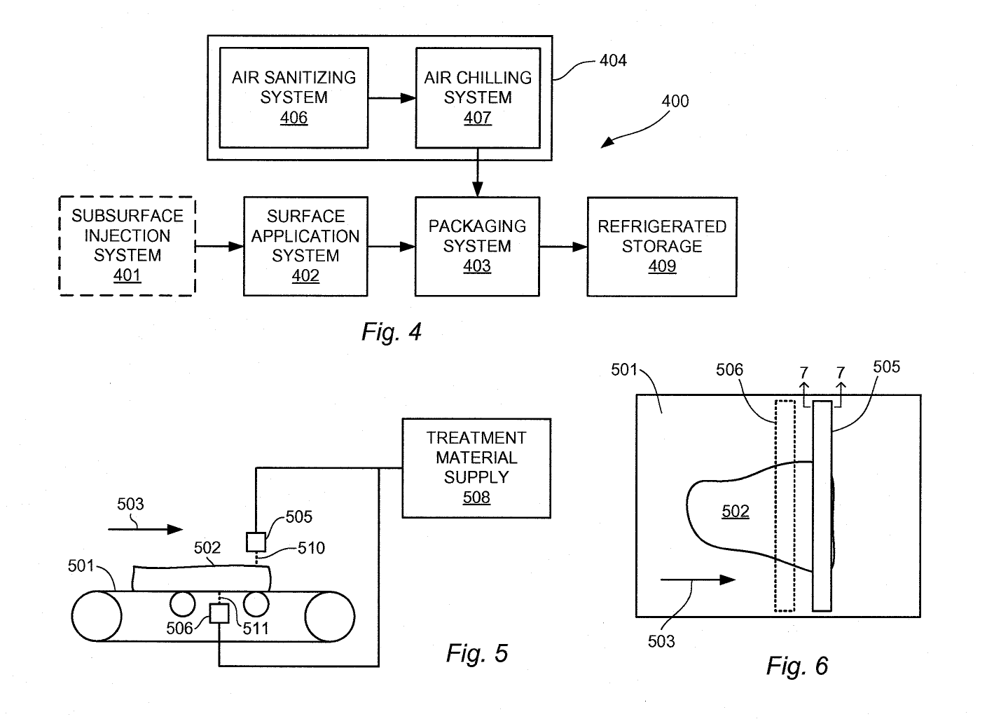

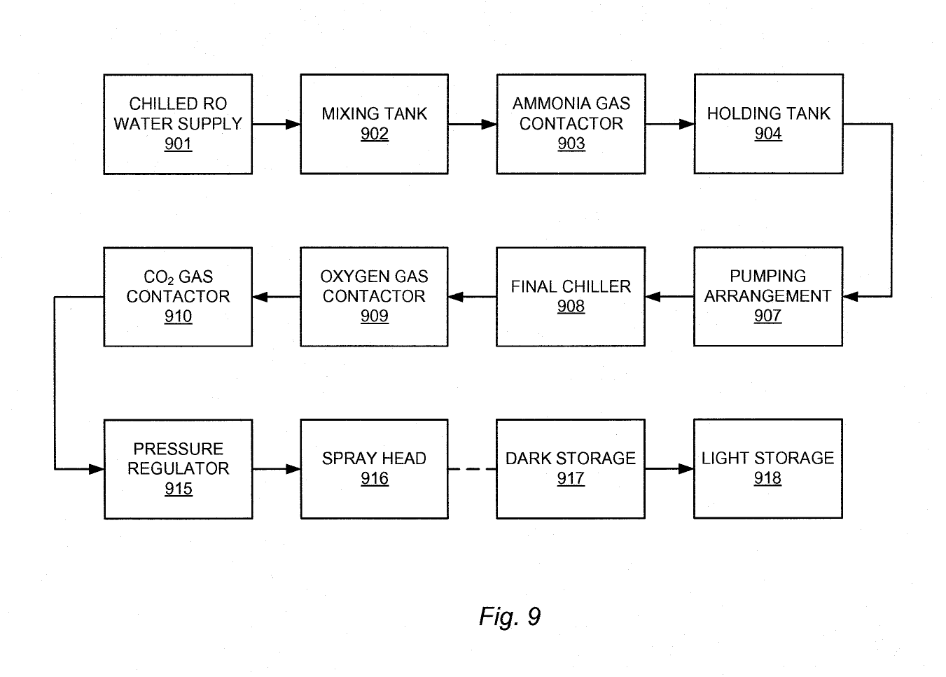

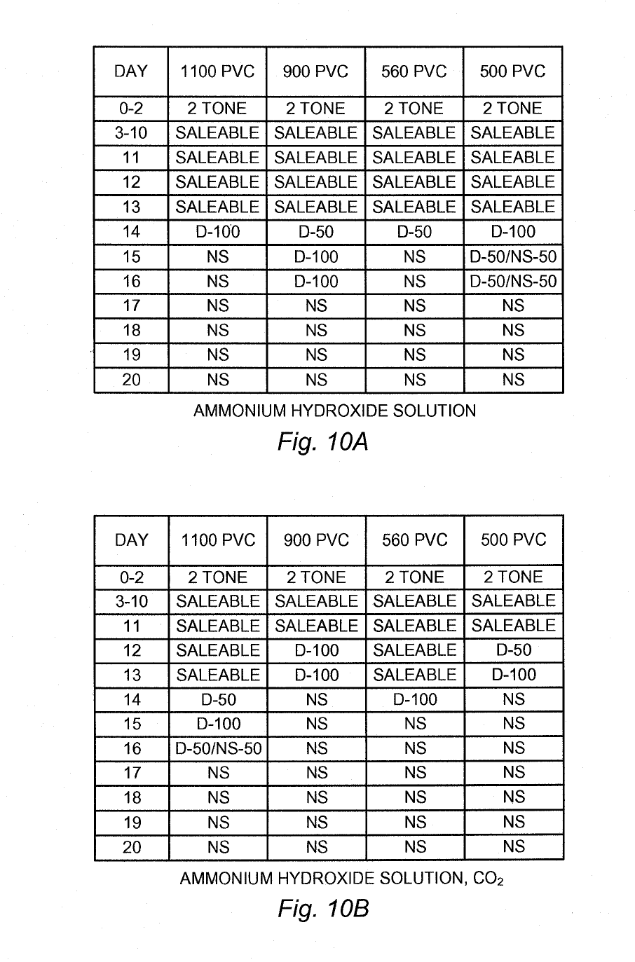

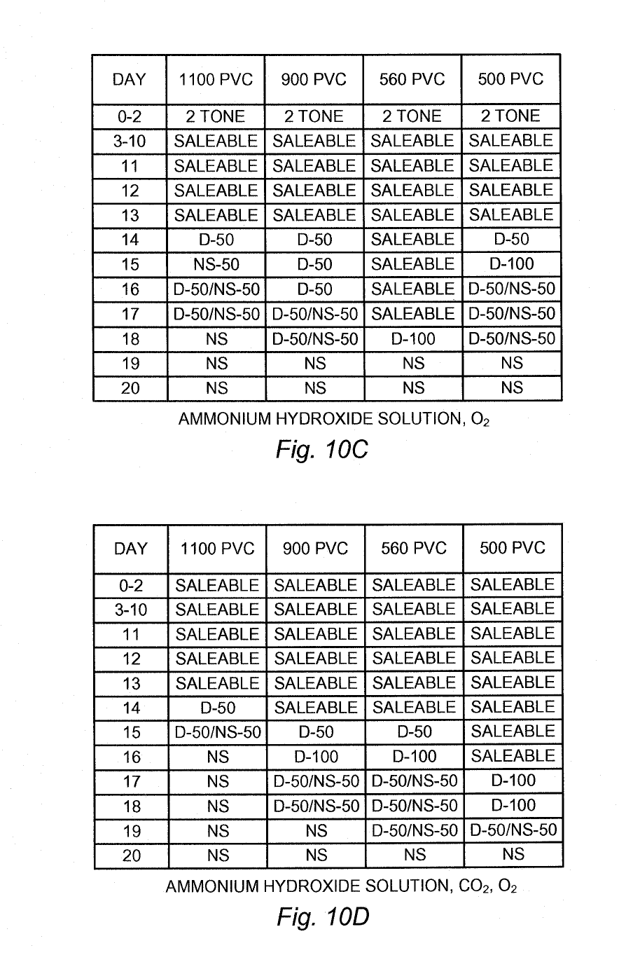

In the following description, FIGS. 1 through 3 will be used to describe various treatment methods within the scope of the present invention. FIG. 4 will be used to describe an apparatus that may be used to treat meat products according to the invention, and FIGS. 5 through 8 will be used to describe certain preferred components of the treatment apparatus shown in FIG. 4. FIG. 9 will be used to describe a test apparatus that has been used to test methods according to the invention, and FIGS. 10A-D show the results of some of these tests.

Referring to FIG. 1, the most basic form of the present invention includes applying an aqueous pH-modified solution to the surface of a meat product at a surface penetrating force as indicated at process block 101, and then exposing the treated meat product to an oxygen atmosphere as shown at process block 102. A method according to the present invention may also include packaging the treated meat product in a suitable isolating package as shown at process block 103 in FIG. 1. As will be discussed in connection with the examples set out below, meat treated according to the method shown in FIG. 1 has been shown to remain wholesome and retain a desirable bright red color for an extended period of time, exceeding 14 days at refrigeration temperatures of approximately 35° F. with the meat held on an expanded polystyrene tray and wrapped with an oxygen-permeable overwrap film.

Applying the aqueous pH-modified solution is preferably performed through a spray nozzle which accelerates a solid stream of the pH-modified solution (with minimal atomization) to a velocity which produces the desired surface penetrating force. Although any suitable spray nozzle may be employed to apply the pH-modified solution, one preferred spray nozzle employs an elongated narrow slot which extends over the entire width or length of the meat product being treated. An example of this preferred nozzle is described below in connection with FIGS. 5 through 7. The examples set out below indicate velocities known to apply an aqueous pH-modified solution at the desired surface penetrating force. Based on this experimentation, it is believed that fluid velocities of approximately 58.9 feet per second to approximately 17.2 feet per second provide the desired surface penetrating force, where the nozzle produced an elongated, thin (between 0.002 and 0.003 inches wide) curtain of the aqueous pH-modified solution. It is noted that this velocity refers to the velocity of the solution as it exits the nozzle; however, the velocity of the solution as it hits the surface of the meat is believed to approximate this value because the nozzle was positioned only a short distance (approximately 2.75 inches) away from the surface of the meat being treated.

It is believed that a number of different factors affect the surface penetrating force applied by a given stream of pH-modified aqueous solution according to the invention. For example, the weight of a given pH-modified aqueous solution affects the force applied by the solution upon impact with the surface of a meat product. For a given fluid velocity, spray configuration, and spacing from the target surface, a relatively heavier pH-modified aqueous solution will apply a relatively higher force to the surface on impact as compared to relatively lighter pH-modified aqueous solution. Thus, the fluid velocity used in applying a given pH-modified aqueous solution may be lower than the fluid velocity used in applying a relatively lighter pH-modified solution and still apply the same force on impact with the target surface.

The nature of the meat product being treated may limit the force at which the pH-modified aqueous solution is applied according to the invention, and thus may limit the fluid velocity at which the solution is sprayed onto the meat product. Specifically, relatively thin cuts of meat can generally accept relatively less application force than thicker cuts of meat before the meat is damaged. For example, the pH-modified aqueous solution application velocity of between 39.2 feet per second to 58.9 feet per second may be acceptable for 1.25 inch thick beef strip steaks, but might damage a three-eighths inch thick beef strip steak.

So as to ensure a substantially consistent application force and surface penetration across the entire treated surface, one or both of the spray nozzle and the meat product being treated are moved relative to each other so that the impact pattern for the sprayed pH-modified solution (for example, a line in the elongated nozzle arrangement) moves steadily and continuously across the surface of the meat product and does not remain at any particular position longer than any other position. This continuous movement of the spray nozzle also helps limit any damage to the meat product that may otherwise be caused by the application of the surface penetrating force. The preferred application method employing the surface penetrating force and continuous movement of the spray nozzle relative to the meat product surface also helps prevent excessive application of pH-modified solution which may have adverse consequences. For example, where the pH-modified solution includes ammonium hydroxide, the penetrating force and continuous relative movement between the meat surface and spray nozzle helps prevent the treated meat from having an undesirable ammonia odor. The rate at which the nozzle moves relative to the target surface of the meat may be dependent upon the velocity of the pH-modified aqueous solution being applied. In particular, a spray nozzle applying a pH-modified aqueous solution at a relatively high fluid velocity, such as between 39.2 feet per second and 58.9 feet per second, may be moved relatively more quickly across the surface being treated as compared to a spray nozzle applying the solution at a lower velocity. As disclosed below in connection with the examples, a nozzle to target movement rate of twenty-one inches per minute has been found appropriate and effective for certain pH-modified solutions applied at a fluid velocity of between 39.2 feet per second and 58.9 feet per second.

Because there are so many factors beyond velocity that affect the penetrating force applied by a stream of liquid, it is also believed that pH-modified solution velocities below 17.2 feet per second may be used to apply the desired surface penetrating force in some cases. For example, it is believed that a pH-modified solution stream at a velocity of 5 feet per second or less may be used to apply the pH-modified solution at a surface penetrating force, provided the stream is moved relatively slowly across the surface of the meat product and provided that the stream is sufficiently narrow to apply the impact over a small surface area.

The preferred application of the pH-modified material under the surface penetrating force adds a significant amount of pH-modified solution to the meat product being treated. It has been shown through experimentation that one preferred application process adds to the meat product an amount of the pH-modified solution sufficient to increase the weight of the meat product by approximately 1.5% to 2%. This preferred application arrangement applied the pH-modified solution to beef strip steak having an approximate thickness of 1.25 inches and an initial weight of approximately 1 pound using an elongated slot application nozzle (with a 0.002 to 0.003 inch slot width) at a nozzle velocity of between approximately 39.2 feet per second to 58.9 feet per second, with the meat product spaced about 2.75 inches from the surface of the meat and the meat product moved relative to the nozzle at a rate of about twenty-one inches per minute. It is believed that an amount of pH-modified solution sufficient to increase the weight of the meat product by approximately 0.5% or more represents an effective amount of the pH-modified solution according to the present invention. It is expected that the weight increase percentage would be relatively higher for thinner steaks (that is, less than 1.25 inches thick) due to the relatively higher surface area per unit weight of the steak, and relatively lower for thicker steaks (over 1.25 inches thick) due to the relatively lower surface area per unit weight of the steak.

It should be noted that applying the pH-modified solution at the surface penetrating force avoids certain problems that have been encountered when applying pH-modified solutions to meat products in other ways. For example, a pH-modified solution may be applied to a meat product by immersing the meat product in the solution. A pH-modified solution may also be applied to a meat product by allowing the solution to wash over the surface of the meat product for a period of time with minimal application force. However, where the pH-modified solution includes ammonium hydroxide it has been found that these immersion and surface washing application techniques without applying the surface penetrating force tend to leave the meat with an undesirable ammonia odor after application of the solution.

The material used to form the aqueous pH-modified solution may include any toxicologically acceptable pH increasing material including hydroxides such as potassium hydroxide and sodium hydroxide, ammonia (which forms ammonium hydroxide with water), water-soluble borates, ortho-phosphates, carbonates (such as potassium carbonate, calcium carbonate, and sodium carbonate), bicarbonates (such as sodium bicarbonate), or any combination of any of these materials. The amount of pH-increasing material used to form the pH-modified solution should be sufficient to produce an unbuffered pH of at least 8.0 and perhaps as high as 12.0, or perhaps higher. The designation “unbuffered pH” is referenced here and elsewhere in this disclosure and accompanying claims to refer to the pH that would result in the solution if the pH-increasing material was the only pH-affecting material in the solution. Other pH-affecting materials may be added to the pH-modified solution after the pH-increasing material is added to reduce the pH, or pH-affecting materials could be added to the makeup water first to produce an initial acid solution and then the pH-increasing material may be added to the solution later. For an example of the former situation in which another pH-affecting material is added after the pH-increasing material, the process shown in FIG. 2 includes applying an acid buffer material to a pH-increased solution, and the final pH of the pH-modified solution is the resulting pH after both the pH-increasing material and the acid buffer material (pH-decreasing material) are added to the makeup water for the aqueous solution. Also, a pH-modified solution applied as shown at process block 101 in FIG. 1 may include salts, flavor enhancers, tenderizers, flavorings, and any other materials that are suitable or desirable for applying to the meat product. Other materials such as carbon monoxide and dissolved oxygen may also be included in the pH-modified solution as will be described further below in connection with FIG. 2, and in connection with the examples. Also, the makeup water for the aqueous pH-modified solution may comprise any suitable water for application to meat products including water purified by reverse osmosis (RO water), tap water, spring water, or any other potable water.

Two preferred combinations of pH-increasing materials for use in producing a pH-modified aqueous solution according to the invention include ammonia and sodium bicarbonate and ammonia and potassium carbonate. When used in combination with ammonia in solution with water, sodium bicarbonate has the advantage of increasing the amount of ammonia gas that goes into solution in the makeup water. For example, by adding 2 ounces of sodium bicarbonate to 600 gallons of makeup water with 2% NaCl by weight, ammonia gas has been injected into the makeup water at a rate of 12 SCFM using the test apparatus described below in connection with FIG. 9. It is noted that all rates expressed as standard cubic feet per minute (SCFM) in this disclosure refer to standard conditions of one atmosphere and 70° F. This 12 SCFM ammonia gas injection rate was sufficient to raise the pH of the resulting solution to 11.9. The added sodium bicarbonate also had the advantage of reducing the ammonia odor from the resulting pH-modified solution.

The final pH of the pH-modified aqueous solution may be any pH that is compatible with the meat product. A pH that is compatible with the meat product (that is, a “compatible pH”) is one that does not produce an adverse affect in the meat product either in terms of taste, color, or any other characteristic. In view of the low quantity of pH-modified solution applied to the meat product and the buffering capacity of meat, the final pH of the pH-modified solution as it is applied to the meat may be as low as 4.0 to as high as 12.0, or higher. In any event, the compatibility of the pH of a given pH-modified aqueous solution may depend upon the particular materials used to modify the pH of the pH-modified solution.

The oxygen exposure step shown at process block 102 in FIG. 1 may be performed in any suitable matter. For example, once the aqueous pH-modified solution is applied to the meat product, the meat product may be held in a temperature-controlled room having a suitable oxygen-containing atmosphere such as air, for example, at ambient atmospheric pressure. Regardless of how the meat is exposed to oxygen, sufficient oxygen should be available to prevent browning in the meat product. It is believed that this browning in the meat product results from the formation of metmyoglobin in the meat product due to insufficient oxygen availability. However when sufficient oxygen is available to the treated meat product, it has been found that the formation of metmyoglobin is inhibited and myoglobin in the meat product is encouraged to remain bound to oxygen in the form of oxymyoglobin. It has been shown that an atmosphere of air provides sufficient oxygen availability to the treated meat product to prevent browning. It has also been shown that where the meat product is packaged in a polystyrene tray with a plastic film overwrap, the overwrap material should have an oxygen permeability (oxygen transmission rate) of no less than 500 cc (at standard temperature and pressure, “STP”) per 100 sq. in. per 24 hours at 1 atmosphere (determined according to ASTM D3985). It is believed that packaging using an overwrap plastic having an oxygen permeability of less than 500 cc (STP) per 100 sq. in. per 24 hours at 1 atmosphere will provide insufficient oxygen to prevent browning in the meat product. It should also be noted that where the treated meat product is packaged, the oxygen exposure required at process block 102 in FIG. 1 may be provided without employing an oxygen-permeable overwrap. For example, a package may incorporate a suitable valve or other structure for allowing oxygen from the exterior atmosphere to enter the interior of the package where it is available to the surface of the treated meat product. Also, the desired oxygen availability to the surface of the meat product may be provided by releasing oxygen from an oxygen releasing agent or structure into the atmosphere surrounding the meat product.

Although the packaging step shown that process block 103 in FIG. 1 is not required according to the present invention, the most preferred forms of the invention do include packaging the meat product after application of the aqueous pH-modified solution. Packaging serves to isolate the treated meat product from microbial contamination and thus helps the treated meat product remain wholesome for longer periods of time. Any suitable packaging may be used to provide the desired microbial isolation, provided the packaging also allows the oxygen exposure shown at process block 102 in FIG. 1. A significant advantage of the present invention is that the process lends itself to simple and inexpensive packaging systems for packaging the treated meat product. In particular, one preferred packaging arrangement places a treated meat product in an expanded polystyrene tray or other suitable tray, and employs an oxygen-permeable overwrap film to cover the meat product in the tray. Suitable packaging devices will be described further below in connection with the treatment system shown in FIG. 4.

It has been found that the process shown in FIG. 1 produces a packaged meat product that is highly resistant to spoilage. It is believed that this resistance to spoilage results from applying the pH-modified solution at a sufficiently high or low pH to kill microbes at the surface of the meat product, and then quickly packaging the meat product in the isolating package under suitably sanitary conditions.

All of the method steps shown in FIG. 1 are preferably performed under normal refrigerated temperature conditions suitable for storing fresh meat products. For example, the meat being treated is preferably maintained at a temperature between approximately 40° F. and approximately 33° F. throughout the process shown in FIG. 1, and during distribution, storage, and display of the resulting packaged meat product. The temperatures within this temperature range between approximately 40° F. and approximately 33° F. each represent an appropriate storage temperature and processing temperature within the scope of the present invention. The temperature of the aqueous pH-modified solution applied at process block 101 is preferably a temperature that is compatible with the desired refrigerated temperature range for the meat. That is, the temperature of the aqueous pH-modified solution applied to the meat product should not be a temperature that would take the meat product out of the desired temperature range between approximately 40° F. and approximately 33° F. for any extended period of time (more than fifteen minutes, for example). For example, the pH-modified solution is applied preferably at a temperature between approximately 40° F. and approximately 24° F.

FIG. 2 illustrates another method embodying the principles of the present invention. The method shown in FIG. 2 includes preparing an aqueous pH-modified solution as shown at process block 201. The aqueous pH-modified solution is then applied to a meat product as shown at process block 202, the treated meat product is packaged as shown at process block 203, and the meat product is then exposed to oxygen as indicated at process block 204. These steps of applying the aqueous pH-modified solution, packaging the treated meat product, and exposing the treated meat product to oxygen correspond to the steps shown in FIG. 1 at process blocks 101, 103, and 102, respectively.

The step of preparing the aqueous pH-modified solution shown in FIG. 2 includes adding a pH-increasing material at process block 205, adding an oxygenating material at process block 206, and adding an acid buffer material at block 207. This sequence shown in FIG. 2 represents a preferred sequence of adding the three different materials to prepare the pH-modified solution. However, other mixing sequences may be used within the scope of the invention. It is also possible within the scope of the invention to eliminate adding the oxygenating material and/or the acid buffer material. That is, the step of preparing the aqueous pH-modified solution may include simply adding the pH-increasing material by itself, or adding the pH-increasing material and the oxygenating material, or adding the pH increasing material and the acid buffer material.

One preferred method which follows the mixing sequence shown in FIG. 2 includes contacting water with ammonia gas to produce an ammonium hydroxide solution. This addition of ammonia gas to produce an ammonium hydroxide solution represents the step at process block 205. Because the acid buffer material is to be added to the pH-modified solution, sufficient ammonia gas is added to the water at process block 205 to produce an ammonium hydroxide solution having an unbuffered pH of at least approximately 8.0. In this preferred mixing arrangement, adding the oxygenating material added as indicated at process block 206 in FIG. 2 includes contacting the ammonium hydroxide solution with oxygen gas to dissolve oxygen gas into the water. Sufficient oxygen gas is added to produce a dissolved oxygen content in the pH-modified solution of at least approximately 8 parts per million (ppm), and more preferably between approximately 8.5 ppm and approximately 10.4 ppm. It is noted that this dissolved oxygen range between approximately 8.5 ppm and approximately 10.4 ppm was obtained by measuring dissolved oxygen content in tested pH-modified solutions using a dissolved oxygen meter according to the Standard Method for the Examination of Water and Wastewater 4500-OG. The amount of oxygenating material necessary to add to the solution to produce these dissolved oxygen contents or higher are considered effective amounts of oxygenating material, and these dissolved oxygen contents or higher are considered effect amounts of dissolved oxygen in the pH-modified aqueous solution. However, it should be noted that a pH-modified solution need not include any dissolved oxygen content in order to be effective at extending meat product shelf life when applied according to the present invention. Dissolved oxygen content in the pH-modified solution does appear to be necessary to produce an immediate bright red color in the meat product as is apparent from the application tests described below and test results shown in FIGS. 10A-D.

The preferred mixing arrangement shown in FIG. 2 also includes adding an acid buffer material to the solution as shown at process block 207. This step may be accomplished by contacting the water with carbon dioxide gas to produce carbonic acid in the solution. Sufficient carbon dioxide gas is preferably added to reduce the pH of the solution and produce a final pH as low as 4.0, and in any event lower than the pH of the solution resulting from addition of the pH-increasing material. This amount of carbon dioxide gas to produce a final pH of approximately 4.0 and above is considered an effective amount of carbon dioxide gas. As discussed below in connection with the examples, sufficient carbon dioxide gas contact with a 11.8 pH ammonium hydroxide and NaCl solution to produce a final pH of approximately 7 is also considered at effective amount of carbon dioxide gas.

Throughout the preferred mixing process required to prepare the pH-modified solution as shown in FIG. 2, the solution is maintained at approximately 40° F. to approximately 32° F. and more preferably between approximately 35° F. and approximately 32° F. Temperatures below 32° F. may be used, but mixing at lower temperatures may be complicated by ice formation in the solution. The resulting pH-modified solution may be chilled further prior to application to the meat product at the step shown at process block 202 in FIG. 2.

The process of preparing the pH-modified solution as shown in FIG. 2 may include many variations within the scope of the invention. For example, where no acid buffer is used, the pH in the solution resulting from the addition of the pH-increasing material may be less than where the acid buffer is used. Also, the oxygenating material added at process block 206 may comprise any material that places dissolved oxygen in the pH-modified solution. For example, both air and pure oxygen gas may comprise an oxygenating material that may be contacted with the water to produce the desired dissolved oxygen content. Dissolved oxygen may also be produced in the pH-modified solution by the addition of hydrogen peroxide. Furthermore, although carbon dioxide gas represents one preferred treatment material to generate the desired acid buffer in the pH-modified solution (the carbon dioxide gas dissolving in water to produce carbonic acid), the acid buffer material applied at process block 207 in FIG. 2 may be any toxicologically acceptable acid buffer material such as food grade hydrochloric acid, phosphoric acid, lactic acid, citric acid, and acetic acid, for example.

Some preferred forms of the invention include carbon monoxide in the pH-modified solution that is applied to the surface of the meat product. Carbon monoxide may be added to the pH-modified solution in any suitable way and in any suitable order in relation to adding other constituents of the pH-modified solution. Substantially all of the carbon monoxide in a pH-modified solution according to the invention is preferably held in solution, although some of the carbon monoxide may remain in gaseous form entrained in the liquid making of the pH-modified solution. In tests similar to those described below in the EXAMPLES section, carbon monoxide has been directed into the chilled salt solution at a rate sufficient to produce a satisfactory concentration of carbon monoxide in the aqueous pH-modified solution.

It should also be noted that the present invention is not limited to any particular arrangement for adding the various materials to prepare the aqueous pH-modified solution. One preferred arrangement for adding the various materials to water to form the aqueous pH-modified solution will be described below further in connection with FIG. 8.

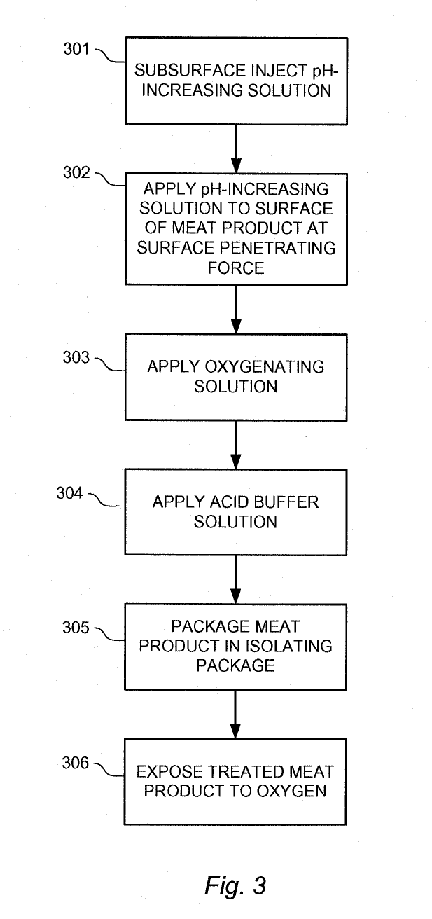

FIG. 3 shows another preferred process within the scope of the present invention. The process shown in FIG. 3 includes first injecting an aqueous pH-modified solution into the interior of a meat product as shown at process block 301. The method then includes separate steps of applying an aqueous pH-increased solution to the surface of the meat product at process block 302, applying an oxygenating solution to the surface of the meat product at process block 303, and applying an acid buffer solution to the surface of the meat product at process block 304. The method then includes packaging the treated meat product in an isolating package as shown at process block 305, and exposing the treated meat product to an oxygen atmosphere as shown at process block 306. These last steps of packaging the meat product and exposing the meat to oxygen correspond to the steps shown at process blocks 103 and 102 as described above in connection with FIG. 1.

It should be noted that although the subsurface injection is shown only in connection with the process in FIG. 3, the subsurface injection step may also be employed with the processes shown in FIGS. 1 and 2. In any case, the subsurface injection is preferably, but not necessarily, performed before applying the aqueous pH-modified solution to the surface of the meat product, or before applying the aqueous pH-increased solution where only a pH-increasing solution is applied. Where the subsurface injection is employed, the injected pH-modified solution may be the same aqueous pH-modified solution applied to the surface of the meat product or may be a different material that is compatible with the aqueous pH-modified solution applied to the surface, and is toxicologically acceptable. One preferred pH-modified solution for injection into the interior of the meat product comprises an ammonium hydroxide solution at a pH of between approximately 8 and 12. It should also be noted that the injected pH-modified solution may include other components such as dissolved or entrained oxygen, an acid buffer material, other pH-modifying materials, salts, flavor enhancers, flavorings, tenderizers, etc. Also, carbon monoxide may be included in the pH-modified solution for injection in substantially the same concentrations as used in the pH-modified solution for surface application according to the present invention, or in different concentrations.

The application sequence of materials to the surface of the meat product shown in FIG. 3 represents one preferred application sequence where materials are applied separately. However alternate forms of the invention may apply the various materials in any order. It is also possible that an aqueous pH-modified solution may be applied to the surface of a meat product as shown at process block 302 in FIG. 3 and then a combined oxygenating solution and acid buffer solution may be added separately in a single step. The oxygenating material may also alternatively be included in the pH-modified solution and the acid buffer alone may be added as a separate step. As compared with the application processes described with reference to FIGS. 1 and 2, the separate application of materials shown in FIG. 3 requires relatively more processing time to conduct the different application steps and/or relatively more complicated processing equipment. The separate application of materials also effectively applies more force to the meat product and this force that may be applied in the course of the multiple application steps increases the risk of damaging the appearance of the meat product.

FIG. 4 illustrates a treatment system 400 that may be used for performing the methods set out in FIGS. 1 and 2 either as shown in those figures or with the addition of a subsurface injection step as shown at process block 301 in FIG. 3. Treatment system 400 includes a subsurface injection system 401, a surface application system 402, and a packaging system 403. FIG. 4 also shows a sanitized air handling system 404 for supplying appropriately filtered and heat sanitized or chemical sanitized air to packaging system 403. The sanitized air is preferably substantially free of live microorganisms and potentially contaminating particles. Finally, system 400 includes a refrigerated storage unit 409 for receiving the packaged meat product from packaging system 403, and for temporarily storing the packaged meat product prior to distribution.

Subsurface injection system 401 may include any suitable injection system. Such injection systems typically include a number of injection needles mounted on a suitable manipulating arrangement so that they may be positioned in a meat product to be treated. Subsurface injection system 401 also preferably includes a separate treatment material supply and distribution arrangement for supplying the desired treatment material to the injection needles for injection into the meat product. Such injection systems are well-known in the field of meat processing and thus will not be described further here so as not to obscure the present invention in unnecessary detail. It should also be noted again that methods according to invention may not include subsurface injection prior to surface application or may include subsurface injection after surface application. Of course, where subsurface injection is performed after the surface application, the subsurface injection system will be located after the surface application system in the process flow.

The surface application system 402 may be any suitable arrangement for applying the desired aqueous pH-modified solution to the surface of the meat product preferably at the surface penetrating force. One preferred surface application arrangement will be described below in connection with FIGS. 5 through 7.

Packaging system 403 may comprise any suitable packaging system for placing the treated meat product in a package that allows the required exposure to oxygen discussed above in connection particularly with process block 102 in FIG. 1. Packaging system 403 need not comprise a vacuum packaging system or a modified atmosphere packaging system. One preferred packaging system 403 comprises a simple overwrap-type system in which the meat product is placed on a tray of polystyrene or other suitable material and the packaging system applies a suitable overwrap film over the top of the meat and tray opening to provide a substantially sealed package interior in which the treated meat is located. The overwrap film may have a suitable oxygen transmission rate (oxygen permeability) as discussed above to provide the oxygen exposure described in connection with process block 102 in FIG. 1. Alternatively, a valve or other structure may be associated with the package for providing he desired oxygen exposure to the treated meat held in the package, or an oxygen releasing material may be enclosed in the interior of the package. It is also noted that the overwrap film may be in contact with the meat product or may not contact the meat product.

Although a modified atmosphere packaging system is not required for packaging system 403 according to the invention, packaging system 403 does preferably maintain a substantially sanitary atmosphere for packaging the treated meat product. For example, treatment system 400 shown in FIG. 4 includes the sanitized air handling arrangement 404 for flooding the packaging area of packaging system 403 with sanitized air. This sanitized air handling system 404 includes an air sanitizing component 406 which may filter and sanitize air by heat sanitization for example, and then supply the heated, sanitized air to the chilling system 407 where the sanitized air is chilled to a suitable temperature preferably between approximately 40° F. and approximately 32° F., and more preferably between approximately 35° F. and approximately 32° F.

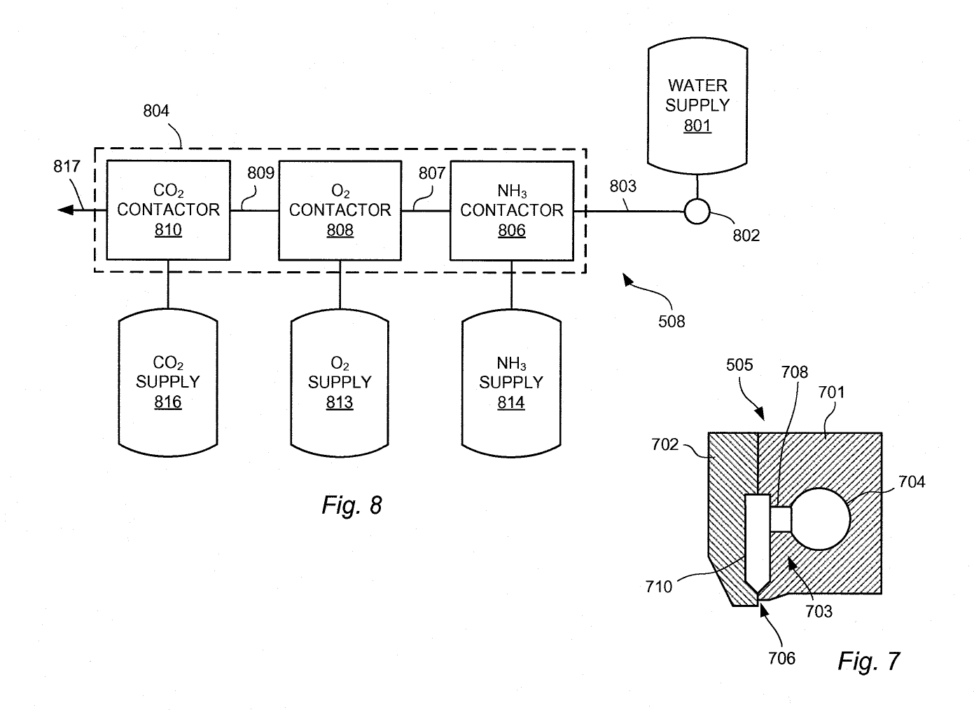

FIGS. 5 and 6 show a preferred surface application system 402 included in the treatment system shown in FIG. 4. Surface application system 402 includes a conveyor 501 for conveying a meat product 502 in a process direction shown by arrow 503. The conveyor belt used in conveyor 501 preferably comprises an open link belt which leaves the bottom surface of meat product 502 substantially exposed for application of the aqueous pH-modified solution. Surface application system 402 also includes an upper spray head (nozzle) 505 and a lower spray head (nozzle) 506. Both spray heads 505 and 506 receive the aqueous pH-modified solution from a treatment material supply 508 at a suitable operating pressure and volume. As will be described further with reference to FIG. 7, each spray head 505 and 506 includes an elongated slot which provides a high velocity, substantially solid curtain of aqueous pH-modified solution directed toward a respective target surface of the meat product 502. These solid streams or curtains of aqueous pH-modified solution are shown at 510 and 511 in FIG. 5. As shown in the top plan view of FIG. 6, each spray head 505 and 506 is elongated so that it extends over the entire width of the meat product 502 on conveyor 501. Each spray head 505 and 506 may extend across the entire width the conveyor belt to accommodate any width of meat product that may be supported on the conveyor belt.

Referring to FIG. 7, a preferred spray head 505 is made up of a first section 701 and second section 702 which are connected together by suitable connectors (connectors not shown). A material distribution arrangement 703 is defined within the area of the two sections 701 and 702. This material distribution arrangement 703 distributes a treatment fluid to an elongated slot in the location referenced by arrow 706 defined between the two sections 701 and 702 (the slot itself is not apparent in the figure due to the scale of the drawing). This slot at location 706 defined between sections 701 and 702 extends substantially the length of the spray head and provides the fluid ejection point at which fluid is ejected from the spray head. Fluid distribution system 403 includes an elongated channel 704 extending substantially the length of the spray head and a number of openings 708 spaced apart along the length of the spray head. These openings 708 connect the channel 704 to a chamber 710 which is also defined between sections 701 and 702. This chamber 710 is open to the slot at the location referenced at 706. Although not shown in FIG. 7 due to scale the drawing, spray head 505 includes a shim interposed between the abutting faces of sections 701 and 702 so as to space the two facing surfaces apart slightly to form the ejection slot referenced at location 706. The shim may be between approximately one one-thousandths to four one-thousandths of an inch thick in order to produce an ejection slot of corresponding width. Ejection slots wider than 0.004 inches may also be used to apply an aqueous pH-modified solution to a meat product according to the present invention. Other types of nozzles or spray heads may also be used to apply the pH-modified solution, although the slot-type nozzle is thought to be particularly suited to the invention.

It should be noted that the example surface application system 402 shown in FIGS. 5 and 6 is merely one preferred arrangement for applying the aqueous pH-modified solution to a surface of the meat product at the desired surface penetrating force. Other application systems may include one or more spray heads that are moved relative to a stationary meat product or a meat product that is advanced in a process direction. Also, although the aqueous pH-modified solution is preferably applied to both the upper and lower surface of the meat product, some forms of the invention may apply the pH-modified solution to only a single surface of the meat product. Also, in order to provide more even application on both major sides of a meat product, an application system may include an arrangement in which one side is sprayed by a spray head positioned above the conveyor belt, and then the meat product is flipped so that the spray head or another spray head above the belt may spray the opposite side.

In order to apply the pH-modified solution to the surface of the meat product at the desired surface penetrating force, it is believed important to apply the solution in the form of a substantially solid stream of the solution with minimal atomization of the solution. In particular, it is believed that atomization of the pH-modified solution at the spray head significantly reduces the application force resulting from the impact of the spray at the surface of the meat product. In order to generate the desired solid stream of the solution, the surfaces of the ejection opening through which the solution exits the spray head may be polished smooth and the edges of the ejection opening may be radiused to form a convex outwardly facing surface. It is further believed that if the pH-modified solution is applied in the form of an atomized liquid, relatively higher velocities will be required (as compared to solid stream velocity) in order to produce the desired surface penetrating force.

FIG. 8 shows an aqueous pH-modified solution supply that may be employed as treatment material supply 508 shown in FIG. 5. The pH-modified solution supply arrangement shown in FIG. 8 includes a water supply 801 comprising a supply of potable makeup water (RO water or tap water for example) for preparing the aqueous pH-modified solution. A pump 802 pumps water from water supply 801 through conduit 803 to a contactor arrangement shown in dashed box 804. Contactor arrangement 804 includes an ammonia contactor 806, which outputs a pH-increased solution to oxygen contactor 808 through conduit 807. Oxygen contactor 808 outputs an oxygenated, pH-increased solution to carbon dioxide contactor 810 via conduit 809. The output at conduit 817 represents the output from the treatment material supply 508 and is directed to the spray heads 505 and 506 shown FIG. 5. Ammonia gas supply 814 directs ammonia gas to ammonia contactor 806, oxygen gas supply 813 directs oxygen gas to oxygen contactor 808, and carbon dioxide gas supply 816 directs carbon dioxide gas to carbon dioxide contactor 810. The gaseous materials may be directed to the respective contactor under the supply pressure maintained in the respective supply vessel. Otherwise, pumps may be used to pump the required materials to the respective contactor.

Each contactor 806, 808, and 810 includes a suitable arrangement that allows the desired gas to contact the water flowing through the contactor to facilitate the dissolution of the material into the water. It will be appreciated that a treatment material supply such as that shown in FIG. 8 may include various valves and fittings for directing and controlling flow. Suitable fittings and valving arrangements are well known in the art and are thus omitted from the drawing. Other equipment such as a chiller and holding vessels may also be included in a treatment material supply according to the present invention. In yet other forms of the invention, the treatment material may be premixed and simply pumped from a suitable storage vessel to the application spray heads (such as 505 and 506 in FIG. 5). The present invention is not limited to any particular arrangement for mixing the makeup water and other constituents used to produce the pH-modified aqueous solution.

Numerous variations on the pH-increasing material supply 508 shown in FIG. 8 are possible within the scope of the present invention. First, the reference to ammonia gas, oxygen gas, and carbon dioxide gas are references to example materials that may be used to produce a suitable aqueous pH-modified material according to the invention. Also, although three separate contactors are shown in FIG. 8, it is possible to mix some or all of the gasses first and then apply the gas mixture to the makeup water through a single contactor. Of course, where only a pH-increasing material is applied to the water to produce the aqueous pH-modified solution, only a single material supply vessel and contactor are required.

Where carbon monoxide is included in the pH-modified solution, a material supply such as that shown in FIG. 8 may include a separate carbon monoxide supply vessel for supplying carbon monoxide gas to a separate contactor in line with the other contactors (806, 808, and 810, for example). Since the carbon monoxide level in the pH-modified solution is maintained at a low level as previously described, it may be desirable to place a separate carbon monoxide contactor last in the series of contactors in the direction of water flow. Other material supplies within the scope of the present invention may not include a separate carbon monoxide gas supply and contactor, but may include some desired carbon monoxide gas fraction mixed with one or more of the other gasses to be contacted with the makeup water for the pH-modified solution.

It should also be noted that although a single pH-modified solution is applied in the surface application system shown in FIGS. 5 and 6, multiple surface application stations may be used to apply two or more separate materials. For example, a first surface application arrangement such as that shown in FIG. 5 may be used to apply a pH-increasing solution, a second surface application arrangement may be used to apply an oxygenating solution, and a third surface application arrangement may be used to apply an acid buffer solution. In yet another alternative arrangement, a single surface application arrangement may receive three different streams of treatment material (pH-increasing solution, oxygenating solution, and acid buffer solution) and a manifold or other control arrangement associated with the single surface application arrangement may be used to selectively switch from one treatment solution to the next for sequential application to the meat product.

### EXAMPLES

A series of tests were performed using the test apparatus shown diagrammatically in FIG. 9. The test apparatus included a chilled RO water supply 901 which chilled RO water to approximately 34° F. A volume of this chilled RO water sufficient to conduct the respective test was placed in a mixing tank 902 and mixed together with table salt (NaCl) at 2% by weight to form a chilled salt solution maintained at approximately 34° F. This chilled salt solution was then pumped at a rate of approximately 15 lbs/minute through a contactor 903 to which pure ammonia gas was supplied at a rate of 7 SCFM. The resulting chilled ammonium hydroxide and salt solution was then held in a holding tank 904 and maintained at approximately 34° F. From the holding tank 904, a pumping arrangement 907 pumped the chilled ammonium hydroxide and salt solution at 150 psig and 36 lbs/minute through a final chiller 908 and then two separate contactors 909 and 910. Final chiller 908 took the ammonium hydroxide and salt solution to approximately 31 to 33° F. The contactors 909 and 910 were used in various tests to add oxygen gas and/or carbon dioxide gas to the ammonium hydroxide and salt solution as will be described further below. Each contactor 909 and 910 was associated with a respective gas vent to remove free gas from the solution after gas contact in the respective contactor. The pressure of the resulting solution downstream from contactor 910 was then regulated down to approximately 30 psig with pressure regulator 915 and this treatment solution was supplied to a spray head 916 such as the spray head 505 described in connection with FIGS. 5-7. The spray head 916 included a single, rectangular orifice measuring 11.75 inches long and between 0.002 and 0.003 inches wide (orifice width varied between about 0.002 and 0.003 inches due to fabrication tolerances in the spray head). The flow rate of 36 lbs/minute and this orifice size produced a calculated spray velocity of between approximately 39.2 feet per second and 58.9 feet per second neglecting any compressibility in the solution. The outlet of the spray head 916 was positioned approximately 2.75 inches above the surface of target meat products carried on a conveyor, and the conveyor was operated during the tests to carry the target meat products under spray head 916 at a substantially constant rate of approximately twenty-one (21) inches per minute.

This test apparatus was used in a series of tests which varied the treatment material, that is, the pH-modified solution, and also varied the packaging used after treatment. Each test was performed on beef strip steaks each cut approximately 1.25 inches thick and having an initial weight of approximately one pound, that had been injected at 18% by weight with an ammonium hydroxide and salt solution (2% NaCl by wt.) having a pH of approximately 11.8. For each test, 12 steaks were treated with the particular treatment material and then placed in a shallow polystyrene tray and over wrapped with a polyvinylchloride (PVC) film such that the film contacted the upper surface of the meat. The treated and packaged steaks were then placed in a refrigerator (dark storage 917) at approximately 35° F. and for 10 days and then moved to a refrigerated display case (light storage 918) for another 10 days. The atmosphere in both the dark storage 917 and light storage 918 was unmodified ambient air at generally ambient air pressure. The refrigerated display case maintained the steaks generally at 35° F. The tests included applying the ammonium hydroxide and salt solution by itself, the ammonium hydroxide and salt solution with oxygen added, with carbon dioxide added, and with both oxygen and carbon dioxide added. Four different polyvinylehloride packaging films were used for each treatment material. The four films had oxygen permeabilities of 1100, 900, 560, and 500, respectively, each value representing cubic centimeters of oxygen (at standard temperature and pressure) per 100 square inches of film, per 24 hours at one atmosphere. The oxygen permeability values for the films were determined by the film manufacturer according to ASTM D3985.

For the tests applying only the ammonium hydroxide and salt solution, the solution was simply pumped through contactors 909 and 910 with the oxygen and carbon dioxide supplies remaining closed off. Where carbon dioxide was added to the solution, it was added through contactor 910 at a rate of 5 SCFM. Approximately 1 SCFM of the carbon dioxide was vented off from a gas vent associated with the contactor, which indicated that approximately 4 SCFM of the carbon dioxide gas went into solution in the fluid being pumped through contactor 910. Where oxygen gas was added to the solution, it was added through contactor 909 also at a rate of 5 SCFM, of which approximately 0.9 SCFM vented off through a gas vent associated with the contactor. This indicates that approximately 4.1 SCFM of oxygen gas went into solution in the ammonium hydroxide and salt solution being pumped through contactor 909.

Immediately after packaging and then once each day during storage, the samples of the treated steaks were observed and the conditions of the steaks recorded. The observation during dark storage included randomly selecting two packaged steaks from each group and moving them for a few seconds to a lighted area for inspection. The observation during light storage was similar in that two packages steaks were selected for inspection at each observation time, but the steaks in light storage could be inspected in the light storage unit and thus did not have to be removed temporarily for inspection. The results of these observations are shown in FIGS. 10A-D. In the observations shown in FIGS. 10A-D, the designation “Saleable” means that the observed steaks had good bright red color one would expect from fresh-cut beef ready for retail sale, with no browning or other discoloration. The designation “D-50,” an abbreviation for “50% Discounted,” means that half of the observed sample included minor discoloration that would require price discounting for retail sale, and the remaining half of the observed sample was in saleable condition. The designation “D-100,” an abbreviation for “100% Discounted,” means that the observed samples included a slight discoloration that would require the price of the product to be discounted at the retail level, but could still be sold as discounted. The designation “D-50/NS-50,” an abbreviation for “50% Discounted and 50% Non-saleable,” means that half of the observed sample included minor color variations that would require price discounting as described above and the remaining half of the observed sample was discolored (as compared to the original presentation) over 50% or more of the exposed surface of the meat and thus could not be sold at the retail level. The designation “NS,” an abbreviation for “Non-saleable,” means that the observed sample was discolored (as compared to the original presentation) over 50% or more of the exposed surface of the meat and thus could not be sold at the retail level. The designation “2 Tone” means that the steak had an uneven color across the treated surface, with a desirable bright red color in some areas and a darker red color elsewhere.

It is noted that a beef strip steak of the type employed in the test, which has been injected with the same ammonium hydroxide and salt solution injected in the test steaks, but which has not had a pH-modified aqueous solution applied to the surface according to the present invention, is expected to have a shelf life of four to five days in an overwrap package of the types used in the tests. The test results shown in FIGS. 10A-D, show that all of the pH-modified aqueous solutions applied according to the present invention significantly increased the self life of the meat product. All of the tests essentially doubled the untreated shelf life, and some of the test treatments more than tripled the expected untreated shelf life to more than fifteen days.

All of the tests results shown in FIGS. 10A-C indicate that the treated steaks were “2-Tone,” that is, uneven in color, for the first two days after treatment. The desirable, consistent bright red color developed in these tests between the second and third day observations. In contrast to this delayed color development shown in the results reported in FIGS. 10A-C, the test in which the pH-modified aqueous solution comprised an ammonium hydroxide and salt solution having an initial pH of approximately 11.8, and to which oxygen gas and carbon dioxide gas are added to produce a dissolved oxygen content of approximately 8.5 ppm and final pH of approximately 7, resulted in an immediate improvement of color to the desired bright red color.

In addition to the tests described above, a test was performed to compare the effect of applying a pH-modified solution to a meat product at a surface penetrating force as opposed to immersing the same type of meat product in the same pH-modified solution. This additional test (the “immersion test”) was performed with a pH-modified solution made up of ammonium hydroxide and NaCl salt together with dissolved carbon dioxide gas and oxygen gas, produced according to the procedure described above in connection with FIG. 9. Specifically, the pH-modified solution for the immersion test was produced according to the same procedure used to produce the ammonium hydroxide/NaCl/CO₂/O₂ solution for which packaging tests results are shown in FIG. 10D. The pH-modified solution had a final pH of approximately 7 and an actual measured oxygen content of 8.5 ppm and was maintained at approximately 35° F. throughout the immersion test.

For the immersion test, twelve beef strip steaks weighing approximately one pound each were immersed in the ammonium hydroxide/NaCl/CO₂/O₂ solution for a total of 30 minutes. Two of the steaks were selected randomly and removed from the pH-modified solution after 5, 10, 20, and 30 minutes of immersion, and checked for surface color, surface penetration of the pH-modified solution, and ammonia odor. Color brightening (brightening to a desirable red color) was used as the indicator for the amount of surface penetration. The selected steak was cut transversely at several locations along the short axis and then observed for depth of brightening; this depth of color brightening was taken as the depth of surface penetration.

The two steaks selected at 5 minutes of immersion showed no affect on surface color, no surface penetration, and had no ammonia odor. The two steaks selected at 10 minutes of immersion showed a slight change in surface color, no surface penetration, and had some noticeable ammonia odor. The steaks selected at 20 minutes of immersion showed a slight surface color improvement, and a surface penetration of approximately one sixty-fourth of an inch at some locations but less or none at other locations, and a definite ammonia odor. The steaks selected at 30 minutes of immersion showed a color improvement similar to that shown in the steaks selected at 20 minutes of immersion, a more even surface penetration but still not more than one sixty-fourth of an inch, and a definite ammonia odor.

These immersion test results show that the application of the pH-modified solution by immersion is far less effective than application of a similarly produced pH-modified solution under a surface penetrating force. Specifically, when the similarly produced ammonium hydroxide/NaCl/CO₂/O₂ solution was applied as described in connection with FIG. 9, the treated steaks showed an immediate and dramatic color improvement (to a desirable bright red color) that was consistent across the entire surface to which the solution was applied through nozzle 916. The surface penetration immediately after application through nozzle 916 was consistently approximately one-eighth of an inch across the entire surface to which the solution was applied, and there was no ammonia odor in the treated steaks.

Another test was performed with the ammonium hydroxide/sodium chloride salt/carbon dioxide/oxygen solution produced as described above for the immersion test and for the test for which results are shown in FIG. 10D. In this test a number of different beef strip steaks were treated with the spray apparatus shown in FIG. 9 at different spray head/application velocities. With the flow rate to the spray head at 29.1 lbs/min resulting in a spray head velocity of between approximately 31.7 feet per second and approximately 47.6 feet per second, the pH-modified solution produced an immediate and consistent bight red color similar to that produced at the higher flow rate and spray head velocity (36 lbs/min and 39.2 ft/s-58.9 ft/s) associated with the test for which results are shown in FIG. 10D. The color brightening effect gradually deceased with a gradual decrease in spray head velocity below the 31 feet per second level. There was no color brightening effect with this pH-modified fluid for spray head velocities below approximately 17.2 feet per second to approximately 25.8 feet per second (15.75 lbs/min flow rate). Based on this test, it is believed that solid curtain sprays at velocities above about 17.2-25.8 feet per second provide the desired surface penetrating force for meat products moving at twenty-one inches per minute through the spray.

The following Table 1 shows the results of an additional test performed using the test apparatus described above in connection with FIG. 9. In this test the flow rate of ammonia gas to contactor 903 was varied in connection with carbon dioxide gas rate and oxygen gas rate to determine the effect on the resulting pH-modified solution. The values shown in Table 1 represent the content of the respective constituent in the resulting solution in terms of parts per million.

TABLE 1

| CFM LEVEL | | | CARBON | |
|---|---|---|---|---|
| OF AMMONIA | GASSES | AMMONIA | DIOXIDE | OXYGEN |
| GAS | APPLIED | (PPM) | (PPM) | (PPM) |
| 7 | NH₃ | 1328 | NA | NA |
| 7 | NH₃/CO₂/O₂ | 1430 | 817 | 8.5 |
| 8 | NH₃ | 1421 | NA | NA |
| 8 | NH₃/CO₂/O₂ | 1595 | 705 | 9.2 |
| 9 | NH₃ | 1630 | NA | NA |
| 9 | NH₃/CO₂/O₂ | 1812 | 491 | 10.4 |

As used herein, whether in the above description or the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another or the temporal order in which acts of a method are performed. Such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the following claims. For example, all of the preferred temperatures and temperature ranges set out above for the aqueous pH-modified solution and for the meat during processing are selected to provide the preferred appropriate conditions for meat processing and storage operations. It is possible to employ temperatures other than the described temperatures or temperature ranges without departing from the scope of the present invention as set out in the following claims.

1. A method of storing a fresh meat product, the method including:
(a) applying an aqueous pH-modified solution in an effective amount to a first surface of the fresh meat product at a surface penetrating force, the aqueous pH-modified solution having a compatible pH and having a temperature that is compatible with a storage temperature for the fresh meat product;
(b) packaging the fresh meat product in an isolating package; and
(c) immediately upon packaging the fresh meat product in the isolating package, maintaining an oxygen-containing atmosphere in an interior of the isolating package.

2. The method of claim 1 wherein maintaining the oxygen-containing atmosphere in the interior of the isolating package is performed by enabling oxygen to traverse an overwrap portion of the isolating package having an oxygen transmission rate of no less than approximately 500 cc (STP) per 100 sq. inches of overwrap portion per 24 hours at one atmosphere.

3. The method of claim 1 further including applying an aqueous carbonic acid solution to the first surface of the fresh meat product in an effective amount prior to packaging the fresh meat product in the isolating package.

4. The method of claim 3 further including applying an aqueous oxygenating solution to the first surface of the fresh meat product in an effective amount prior to packaging the fresh meat product in the isolating package, the aqueous oxygenating solution having a dissolved oxygen content above approximately 8.0 ppm.

5. The method of claim 1 further including applying an aqueous oxygenating solution to the first surface of the fresh meat product in an effective amount prior to packaging the fresh meat product in the isolating package, the aqueous oxygenating solution having an oxygen content above approximately 8.0 ppm.

6. The method of claim 1 wherein the aqueous pH-modified solution is buffered with an acid solution from an unbuffered pH of at least approximately 8.0 to a buffered pH of no less than approximately 4.0.

7. The method of claim 6 wherein the acid solution comprises carbonic acid.

8. The method of claim 6 wherein the aqueous pH-modified solution includes a dissolved oxygen content of no less than approximately 8.0 ppm.

9. The method of claim 1 wherein the aqueous pH-modified solution includes a dissolved oxygen content of no less than approximately 8.0 ppm.

10. The method of claim 1 further including injecting an interior treatment material into the interior of the fresh meat product with one or more injection conduits prior to applying the aqueous pH-modified solution.

11. The method of claim 1 wherein the aqueous pH-modified solution includes an ammonium hydroxide solution and the pH of the pH-modified solution is formed solely from the ammonium hydroxide content in the aqueous pH-modified solution.

12. The method of claim 1 wherein the aqueous pH-modified solution is applied to the first surface of the fresh meat product at a velocity of no less than approximately 17.2 feet per second to produce the surface penetrating force.

13. A method of storing a fresh meat product at a storage temperature, the method including:
(a) producing an aqueous pH-modified solution having a temperature compatible with the storage temperature, the aqueous pH-modified solution having an unbuffered pH of no less than approximately 8.0, and including a dissolved oxygen content of no less than approximately 8.0 ppm;
(b) buffering the aqueous pH-modified solution with carbonic acid to produce a buffered aqueous pH-modified solution having a pH no less than 4.0;
(c) applying an effective amount of the buffered aqueous pH-modified solution to a first surface of the fresh meat product at a surface penetrating force;
(d) packaging the fresh meat product in an isolating package after applying the buffered aqueous pH-modified solution; and
(e) enabling oxygen to reach the first surface of the fresh meat product when the fresh meat product is in the isolating package.

14. The method of claim 13 wherein enabling oxygen to reach the first surface of the fresh meat product includes providing an oxygen-permeable overwrap over the first surface of the fresh meat product, the oxygen-permeable overwrap having an oxygen transmission rate of no less than approximately 500 cc (STP) per 100 sq. inches per 24 hours at one atmosphere.

15. The method of claim 13 wherein producing the aqueous pH-modified solution having an initial pH of no less than approximately 8.0 includes forming ammonium hydroxide in the aqueous pH-modified solution.

16. A method of storing a fresh meat product, the method including:
(a) applying an effective amount of an aqueous pH-modified solution to a first surface of the fresh meat product at a surface penetrating force, the aqueous pH-modified solution (i) having a temperature compatible with a storage temperature for the fresh meat product, (ii) having a pH that is compatible with the fresh meat product, and (iii) including a dissolved oxygen content of no less than approximately 8.0 ppm; and
(b) maintaining the fresh meat product in an atmosphere having an oxygen content for at least eleven days at an appropriate storage temperature for the fresh meat product.

17. The method of claim 16 wherein the fresh meat product is held in an isolating package comprising a tray within which the fresh meat product rests and an overwrap film substantially sealed around an upper tray opening defined by the tray, and wherein maintaining the fresh meat product in the atmosphere having the oxygen content for at least eleven days includes enabling oxygen gas to traverse the overwrap film at a rate of no less than that provided by a film having an oxygen permeability of no less than approximately 500 cc (STP) per 100 sq. inches per 24 hours at one atmosphere.

18. The method of claim 17 wherein the aqueous pH-modified solution is formed by producing both an ammonium hydroxide content and a carbonic acid content in a suitable makeup water such that the aqueous pH-modified solution has a final pH of no less than approximately 4.0.

19. A method of storing a fresh meat product at a storage temperature appropriate for the fresh meat product, the method including:
(a) applying an effective amount of an aqueous pH-modified solution to a first surface of the fresh meat product at a surface penetrating force, the aqueous pH-modified solution having a temperature compatible with the storage temperature and having a pH of no less than approximately 4.0; and
(b) holding the fresh meat product in an isolating package including an open-topped tray with an overwrap film portion secured over the open top of the tray, the overwrap film having an oxygen transfer rate of no less than approximately 500 cc (STP) per 100 sq. inches per 24 hours at one atmosphere.

20. The method of claim 19 wherein the aqueous pH-modified solution is formed by producing an ammonium hydroxide content in a makeup water sufficient to produce an unbuffered pH of no less than approximately 8.0, and further including buffering the aqueous pH-modified solution from the unbuffered pH of no less than approximately 8.0 to a pH of no less than 4.0 with carbonic acid.

21. The method of claim 19 wherein the aqueous pH-modified solution includes a dissolved oxygen content of no less than approximately 8.0 ppm.
